(19) United States
(12) Patent Application Publication
(10) Pub. No.: US 2025/0202605 A1
(43) Pub. Date: Jun. 19, 2025

(54) COMMUNICATION METHOD AND APPARATUS

(71) Applicant: HUAWEI TECHNOLOGIES CO., LTD., Shenzhen, Guangdong (CN)

(72) Inventors: Xiaoyan BI, Shanghai (CN); Chenglong JIANG, Shanghai (CN); Yong LIU, Shanghai (CN); Lei LIU, Shanghai (CN)

(21) Appl. No.: 19/064,865

(22) Filed: Feb. 27, 2025

Related U.S. Application Data
(63) Continuation of application No. PCT/CN2022/116165, filed on Aug. 31, 2022.

(51) Int. Cl. H04B 17/345; H04L 25/02

(52) U.S. Cl. CPC H04B 17/345; H04L 25/0202

(57) ABSTRACT

This application provides a communication method and apparatus, to reduce complexity of channel estimation at a receiving end and improve performance of the receiving end. The method includes: A first terminal apparatus receives first information, where the first information indicates a port or ports corresponding to a first interference layer of the first terminal apparatus, the first interference layer is one or more interference layers in a plurality of interference layers of the first terminal apparatus, and the first interference layer is a transmission layer of a second terminal apparatus. The first terminal apparatus performs channel estimation based on the port(s) corresponding to the first interference layer.

### CROSS-REFERENCE TO RELATED APPLICATIONS

This application is a continuation of International Application No. PCT/CN2022/116165, filed on Aug. 31, 2022, the disclosure of which is hereby incorporated by reference in its entirety.

### TECHNICAL FIELD

This application relates to the field of mobile communication technologies, and in particular, to a communication method and apparatus.

### BACKGROUND

In a communication system, to send and receive data, obtain system synchronization and feedback channel information, an uplink channel or a downlink channel needs to be estimated. Channel estimation (CE) (or referred to as channel measurement) is a process of reconstructing or restoring a received signal to compensate for signal distortion caused by channel fading and noise, where time-domain and frequency-domain changes of a channel are tracked by using known standard signals of a transmitting end and a receiving end. The standard signal may also be referred to as a pilot signal or a reference signal (RS). The standard signals are distributed on different resource elements (REs) in time-frequency two-dimensional space in an orthogonal frequency division multiplexing (OFDM) symbol, and have a known amplitude and phase.

However, currently, the receiving end needs to determine a port or ports for performing channel estimation. For a massive multiple-input multiple-output (MIMO) scenario and the like, a quantity of antenna ports is large. Consequently, processing at the receiving end is excessively complex, a large quantity of resources are occupied, and performance of the receiving end is affected.

### SUMMARY

This application provides a communication method and apparatus, to reduce complexity of channel estimation at a receiving end and improve performance of the receiving end.

According to a first aspect, this application provides a communication method, to reduce complexity of channel estimation at a receiving end and improve performance of the receiving end. The method may be implemented by a first terminal apparatus. The first terminal apparatus may be a terminal device or a component in the terminal device. The component in this application may include, for example, at least one of a processor, a transceiver, a processing unit, or a transceiver unit. For example, an execution body is the first terminal apparatus. The method may be implemented by using the following steps: The first terminal apparatus receives first information, where the first information indicates a port or ports corresponding to a first interference layer of the first terminal apparatus, the first interference layer is one or more interference layers in a plurality of interference layers of the first terminal apparatus, and the first interference layer is a transmission layer of a second terminal apparatus. The first terminal apparatus performs channel estimation based on the port(s) corresponding to the first interference layer.

According to the method shown in the first aspect, in this application, the first terminal apparatus may perform, based on the first information, channel estimation on the port(s) corresponding to the first interference layer indicated by the first information, so that complexity of the channel estimation of the first terminal apparatus can be reduced, and receiving performance of the first terminal apparatus can be improved.

In a possible implementation, the first terminal apparatus may determine an equalization coefficient based on a result of the channel estimation, and receive data based on the equalization coefficient.

According to this implementation, the first terminal apparatus may determine the equalization coefficient based on the estimation result, and receive data based on the equalization coefficient to reduce interference.

In a possible implementation, the first terminal apparatus may perform channel estimation based on a first time-frequency resource, where the first time-frequency resource corresponds to the port(s) corresponding to the first interference layer. According to this implementation, a time-frequency resource on which channel estimation needs to be performed can be accurately determined, thereby improving channel estimation accuracy.

In a possible implementation, the first terminal apparatus may perform channel estimation based on the first time-frequency resource, and a time-frequency resource corresponding to noise and/or a time-frequency resource corresponding to to-be-transmitted data. According to this implementation, the channel estimation accuracy can be further improved.

In a possible implementation, the first interference layer is determined based on interference energy, and the interference energy of the first interference layer satisfies at least one of the following: the interference energy of the first interference layer is higher than interference energy of a second interference layer, and the plurality of interference layers further include the second interference layer; the interference energy of the first interference layer is not less than an energy threshold; a proportion of the interference energy of the first interference layer in total interference energy is not less than a proportion threshold, and the total interference energy is a sum of interference energy of all interference layers of the first terminal apparatus; the first interference layer includes a plurality of interference layers, and a sum of interference energy of the plurality of interference layers is not less than an energy threshold; the first interference layer includes a plurality of interference layers, a proportion of a sum of interference energy of the plurality of interference layers in total interference energy is not less than a proportion threshold, and the total interference energy is a sum of interference energy of all interference layers of the first terminal apparatus; and the first interference layer is N interference layers with highest interference energy in the plurality of interference layers, where N is a positive integer.

According to this implementation, the first interference layer may be flexibly determined based on a transmission requirement.

In a possible implementation, the first information includes indication information of the port(s) corresponding to the first interference layer and/or indication information of a port or ports corresponding to the second interference layer, and the second interference layer does not include the first interference layer.

According to this implementation, the first interference layer and/or the second interference layer other than the first interference layer may be flexibly indicated based on the port indication information.

In a possible implementation, the first information further includes indication information of a port group. The first terminal apparatus may further determine, based on a port or ports corresponding to the to-be-transmitted data, a port or ports in the port group, and the indication information of the port(s) corresponding to the first interference layer and/or the indication information of the port(s) corresponding to the second interference layer, the port corresponding to the first interference layer.

According to this implementation, the first interference layer and/or the second interference layer may be flexibly indicated based on the port indication information and the indication information of the port group.

In a possible implementation, the first information includes the indication information of the port group. The first terminal apparatus may determine, based on the port(s) corresponding to the to-be-transmitted data and the port(s) in the port group, the port(s) corresponding to the first interference layer.

According to this implementation, the first interference layer and/or the second interference layer may be flexibly indicated based on the indication information of the port group.

According to a second aspect, this application provides a communication method, to reduce complexity of channel estimation at a receiving end and improve performance of the receiving end. The method may be implemented by a network device or a component (for example, a network apparatus) in the network device. The component in this application may include, for example, at least one of a processor, a transceiver, a processing unit, or a transceiver unit. For example, an execution body is the network device. The method may be implemented by using the following steps: The network device determines first information, where the first information indicates a port or ports corresponding to a first interference layer of a first terminal apparatus, the first interference layer is one or more interference layers in a plurality of interference layers of the first terminal apparatus, and the first interference layer is a transmission layer of a second terminal apparatus. The network device sends the first information to the first terminal apparatus.

In a possible implementation, the first interference layer is determined based on interference energy, and the interference energy of the first interference layer satisfies at least one of the following: the interference energy of the first interference layer is higher than interference energy of a second interference layer, and the plurality of interference layers further include the second interference layer; the interference energy of the first interference layer is not less than an energy threshold; a proportion of the interference energy of the first interference layer in total interference energy is not less than a proportion threshold, and the total interference energy is a sum of interference energy of all interference layers of the first terminal apparatus; the first interference layer includes a plurality of interference layers, and a sum of interference energy of the plurality of interference layers is not less than an energy threshold; the first interference layer includes a plurality of interference layers, a proportion of a sum of interference energy of the plurality of interference layers in total interference energy is not less than a proportion threshold, and the total interference energy is a sum of interference energy of all interference layers of the first terminal apparatus; and the first interference layer is N interference layers with highest interference energy in the plurality of interference layers, where N is a positive integer.

In a possible implementation, the first information includes indication information of the port(s) corresponding to the first interference layer and/or indication information of a port or ports corresponding to the second interference layer, and the second interference layer does not include the first interference layer.

In a possible implementation, the first information further includes indication information of a port group, and a port or ports in the port group, a port or ports corresponding to to-be-transmitted data of the first terminal apparatus, and the indication information of the port(s) corresponding to the first interference layer and/or the indication information of the port(s) corresponding to the second interference layer are used to determine the port(s) corresponding to the first interference layer.

In a possible implementation, the first information includes indication information of a port group, and a port or ports in the port group and a port or ports corresponding to to-be-transmitted data are used to determine the port(s) corresponding to the first interference layer.

According to a third aspect, a communication apparatus is provided. The apparatus may implement the method performed by the first terminal apparatus in any possible implementation of the first aspect, or may be configured to implement the method performed by the network device in the second aspect and any possible design of the second aspect. The apparatus is, for example, a first terminal apparatus, a network device, or a component in the network device.

In an optional implementation, the apparatus may include modules that are in one-to-one correspondence with the methods/operations/steps/actions described in the first aspect and the second aspect and any possible implementation. The module may be implemented by a hardware circuit, software, or a hardware circuit in combination with software. In an optional implementation, the apparatus includes a processing unit (also referred to as a processing module sometimes) and a communication unit (also referred to as a communication module, a transceiver module, or a transceiver unit sometimes). The communication unit can implement a sending function and a receiving function. When the communication unit implements the sending function, the communication unit may be referred to as a sending unit (also referred to as a sending module sometimes). When the communication unit implements the receiving function, the communication unit may be referred to as a receiving unit (also referred to as a receiving module sometimes). The sending unit and the receiving unit may be a same functional module, and the functional module can implement the sending function and the receiving function; or the sending unit and the receiving unit may be different functional modules, and the transceiver unit is a general term for these functional modules.

For another example, the apparatus includes a processor, coupled to a memory, and the processor is configured to execute instructions in the memory, to implement the method described in the first aspect and the second aspect and any possible implementation. Optionally, the apparatus further includes another component, for example, an antenna, an input/output module, and an interface. The components may be hardware, software, or a combination of software and hardware.

According to a fourth aspect, a communication method is provided. The communication method may include the method performed by the first terminal apparatus in the first aspect and any possible design of the first aspect, and the method performed by the network device in the second aspect and any possible design of the second aspect. Optionally, the communication method may be implemented by a communication system including the first terminal apparatus and the network device.

According to a fifth aspect, a computer-readable storage medium is provided. The computer-readable storage medium is configured to store a computer program or instructions, and when the computer program is run or the instructions are run, the method in any one of the first aspect and the second aspect is implemented.

According to a sixth aspect, a computer program product including instructions is provided. When the computer program product runs on a computer, the method in any one of the first aspect and the second aspect is implemented.

According to a seventh aspect, a chip system is provided. The chip system includes a logic circuit (which may alternatively be understood as that the chip system includes a processor, and the processor may include a logic circuit and the like), and may further include an input/output interface. The input/output interface may be configured to receive a message, or may be configured to send a message. The input/output interface may be a same interface, to be specific, a same interface can implement both a sending function and a receiving function. Alternatively, the input/output interface includes an input interface and an output interface. The input interface is configured to implement a receiving function, in other words, configured to receive a message. The output interface is configured to implement a sending function, in other words, configured to send a message. The logic circuit may be configured to perform an operation other than the sending and receiving functions in the method described in the first aspect and the second aspect and any possible implementation. The logic circuit may be further configured to transmit a message to the input/output interface, or receive, from the input/output interface, a message from another communication apparatus. The chip system may be configured to implement the method described in the first aspect and the second aspect and any possible implementation. The chip system may include a chip, or may include a chip and another discrete device.

Optionally, the chip system may further include a memory, and the memory may be configured to store instructions. The logic circuit may invoke the instructions stored in the memory to implement a corresponding function.

According to an eighth aspect, a communication system is provided. The communication system may include an apparatus configured to implement the first aspect and any possible design of the first aspect, for example, the first terminal apparatus, and an apparatus configured to implement the second aspect and any possible design of the second aspect, for example, the network device.

For technical effects brought by the second aspect to the eighth aspect, refer to the descriptions of the first aspect. Details are not described herein again.

### BRIEF DESCRIPTION OF DRAWINGS

FIG. 1 is a diagram of an architecture of a wireless communication system according to an embodiment of this application;

FIG. 2 is a diagram of an architecture of another wireless communication system according to an embodiment of this application;

FIG. 3 is a schematic flowchart of a communication method according to an embodiment of this application;

FIG. 4 is a diagram of a first interference layer and a second interference layer according to an embodiment of this application;

FIG. 5 is a diagram of a DMRS pattern according to an embodiment of this application;

FIG. 6 is a diagram of a structure of a communication apparatus according to an embodiment of this application;

FIG. 7 is a diagram of a structure of another communication apparatus according to an embodiment of this application; and

FIG. 8 is a diagram of a structure of another communication apparatus according to an embodiment of this application.

### DESCRIPTION OF EMBODIMENTS

Embodiments of this application provide a communication method and apparatus. The method and the apparatus are based on a same inventive concept. Because problem-resolving principles of the method and the apparatus are similar, mutual reference may be made to implementations of the apparatus and the method, and repeated parts are not described. In descriptions of embodiments of this application, the term “and/or” describes an association relationship between associated objects and indicates that three relationships may exist. For example, A and/or B may indicate the following three cases: Only A exists, both A and B exist, and only B exists. The character “/” generally indicates an “or” relationship between the associated objects. In this application, “at least one” means one or more, and “a plurality of” means two or more. In addition, it should be understood that in the descriptions of this application, terms such as “first” and “second” are only used for distinguishing and description, but should not be understood as indicating or implying relative importance, or should not be understood as indicating or implying a sequence.

The method provided in embodiments of this application may be applied to a 4th generation (4G) communication system, for example, a long term evolution (LTE) communication system, or may be applied to a 5th generation (5G) communication system, for example, a 5G new radio (NR) communication system, or may be applied to various future communication systems, for example, a 6th generation (6G) communication system. The method provided in embodiments of this application may be further applied to a Bluetooth system, a wireless fidelity (Wi-Fi) system, a long range radio (LoRa) system, or an internet of vehicles system. The method provided in embodiments of this application may be further applied to a satellite communication system. The satellite communication system may be integrated with the foregoing communication system.

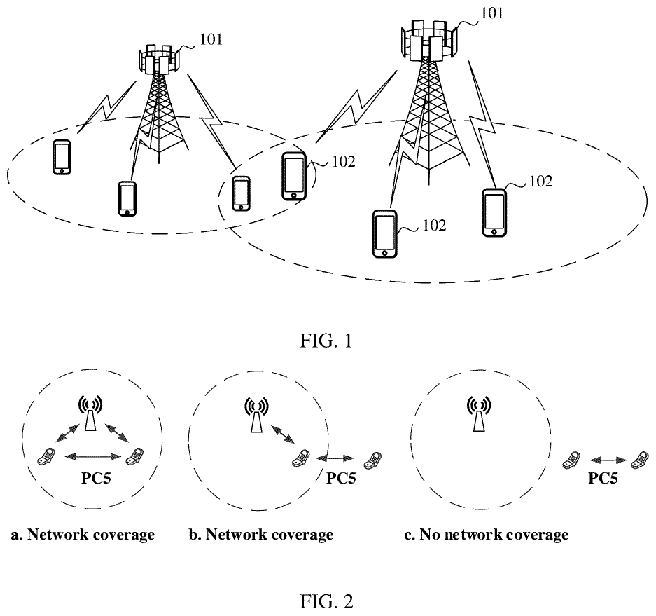

For ease of understanding embodiments of this application, an application scenario used in this application is described by using an architecture of a communication system shown in FIG. 1 as an example. As shown in FIG. 1, the communication system includes network devices 101 and terminal devices 102. The apparatus provided in this embodiment of this application may be used in the network device 101 or the terminal device 102. It may be understood that FIG. 1 shows only one possible communication system architecture to which embodiments of this application may be applied. In another possible scenario, the communication system architecture may alternatively include another device.

The network device 101 is a node in a radio access network (RAN), and may also be referred to as a base station or a RAN node (or device). Currently, some examples of an access network device are: a next generation base station (gNodeB/gNB/NR-NB), a transmission reception point (TRP), an evolved NodeB (eNB), a radio network controller (RNC), a NodeB (NB), a base station controller (BSC), a base transceiver station (BTS), a home base station (for example, a home evolved NodeB or a home NodeB, HNB), a baseband unit (BBU), a wireless fidelity (Wi-Fi) access point (AP), a satellite device, a network device in a 5G communication system, or a network device in a possible future communication system. Alternatively, the network device 101 may be another device having a network device function. For example, the network device 101 may alternatively be a device functioning as a network device in device to device (D2D) communication, internet of vehicles communication, or machine-communication. Alternatively, the network device 101 may be a network device in a possible future communication system.

In some deployments, a gNB may include a central unit (CU) and a distributed unit (DU). The gNB may further include a radio unit (RU). The CU implements some functions of the gNB, and the DU implements some functions of the gNB. For example, the CU implements functions of a radio resource control (RRC) layer and a packet data convergence protocol (PDCP) layer. The DU implements functions of a radio link control (RLC) layer, a media access control (MAC) layer, and a physical (PHY) layer. Information at the RRC layer eventually becomes information at the PHY layer, or is converted from the information at the PHY layer. Therefore, in the architecture, higher layer signaling such as RRC layer signaling or PHCP layer signaling may alternatively be considered as being sent by the DU or sent by the DU and the RU. It may be understood that the network device may be a CU node, a DU node, or a device including the CU node and the DU node. In addition, the CU may be classified as a network device in an access network RAN, or the CU may be classified as a network device in a core network CN. This is not limited herein.

The terminal device 102 may also be referred to as a user equipment (UE), a mobile station (MS), a mobile terminal (MT), or the like, and is a device that provides a user with voice or data connectivity, or may be an internet of things device. For example, the terminal device includes a handheld device, a vehicle-mounted device, or the like that has a wireless connection function. Currently, the terminal device may be a mobile phone, a tablet computer, a laptop computer, a palmtop computer, a mobile internet device (MID), a wearable device (for example, a smartwatch, a smart band, or a pedometer), a vehicle-mounted device (for example, a car, a bicycle, an electric vehicle, an airplane, a ship, a train, or a high-speed rail), a virtual reality (VR) device, an augmented reality (AR) device, a wireless terminal in industrial control, a smart household device (for example, a refrigerator, a television, an air conditioner, or an electricity meter), an intelligent robot, a workshop device, a wireless terminal in self driving, a wireless terminal in a remote surgery, a wireless terminal in a smart grid, a wireless terminal in transportation safety, a wireless terminal in a smart city, a wireless terminal in a smart home, a flight device (for example, an intelligent robot, a hot air balloon, an unmanned aerial vehicle, or an airplane), or the like. The terminal device may alternatively be another device having a terminal function. For example, the terminal device may alternatively be a device functioning as a terminal in D2D communication. In this application, a terminal device having a wireless transceiver function and a chip that can be disposed in the terminal device are collectively referred to as the terminal device.

In addition, as shown in FIG. 2, the communication method provided in embodiments of this application may be further applied to a system in which terminal devices directly communicate with each other. For example, the terminal devices communicate with each other based on a direct cellular communication protocol (PC5). Therefore, the method may be applicable to a communication scenario with network coverage (as shown by a number a or a number b in FIG. 2) and a communication scenario without network coverage (as shown by a number c in FIG. 2).

It may be understood that in the scenario shown in FIG. 1, the network device 101 and the terminal device 102 perform wireless communication based on a universal terrestrial radio access network to UE (UTRAN-to-UE, Uu) air interface.

However, in a scenario in which terminal devices communicate with each other, both a receiving end and a transmitting end in wireless communication are terminal devices.

For example, the network device may be a conventional macro base station evolved NodeB (eNB) in a universal mobile telecommunications system (UMTS) or an LTE wireless communication system, may be a micro base station eNB in a HetNet (Heterogeneous Network) scenario, may be a baseband unit (base band unit) and a remote radio unit (RRU) in a distributed base station scenario, may be a baseband unit pool (BBU pool) and an RRU in a cloud radio access network (CRAN) scenario, or may be a gNB in a future wireless communication system. The terminal device may be a vehicle-mounted communication module or another embedded communication module, or may be a handheld communication device of a user, including a mobile phone, a tablet computer, or the like.

For ease of understanding of embodiments of this application, the following first briefly describes terms and backgrounds in this application.

### 1. Antenna Port

The antenna port is referred to as a port for short, and may be understood as a transmit antenna identified by a receiving end, or a transmit antenna that can be spatially distinguished. One antenna port may be configured for each virtual antenna, and each virtual antenna may be a weighted combination of a plurality of physical antennas. Antenna ports may be classified into a reference signal port and a data port based on different signals carried by the antenna ports. The reference signal port includes, for example, but is not limited to, a demodulation reference signal (DMRS) port and a channel state information reference signal (CSI-RS) port.

This application includes an existing port and a newly added port. The existing port is a port in an existing protocol, or a port that supports technical solutions in the existing protocol. The newly added port is a port that can support the technical solutions in this application.

### 2. Time-Frequency Resource

In embodiments of this application, data or information may be carried by using the time-frequency resource. The time-frequency resource may include a time-domain resource and a frequency-domain resource. In time domain, the time-frequency resource may include one or more time-domain units (which may also be referred to as time units or time elements). In frequency domain, the time-frequency resource may include one or more frequency-domain units.

One time-domain unit may be one symbol or several symbols (for example, an OFDM symbol), or one mini-slot, or one slot, or one subframe. Duration of one subframe in time domain may be 1 millisecond (ms). One slot includes seven or 14 symbols. One mini-slot may include at least one symbol (for example, two symbols, seven symbols, 14 symbols, or any quantity of symbols less than or equal to 14 symbols). Sizes of the foregoing time-domain units are only used for ease of understanding of the solutions in this application, and are not limited to the protection scope of embodiments of this application. It may be understood that the sizes of the foregoing time-domain units may be other values, and this is not limited in this application.

One frequency-domain unit may be one resource block (RB), or one subcarrier, or one resource block group (RBG), or one predefined sub-band, or one precoding resource block group (PRG), or one bandwidth part (BWP), or one resource element (RE) (or a resource element), or one carrier, or one serving cell.

A transmission unit mentioned in embodiments of this application may include any one of the following: a time-domain unit, a frequency-domain unit, or a time-frequency unit. For example, the transmission unit mentioned in embodiments of this application may be replaced with a time-domain unit, or may be replaced with a frequency-domain unit, or may be replaced with a time-frequency unit. For another example, the transmission unit may be alternatively replaced with a transmission occasion. The time-domain unit may include one or more OFDM symbols, one or more slots, or the like. The frequency-domain unit may include one or more RBs, one or more subcarriers, or the like.

### 3. Transmission Layer

The transmission layer may also be referred to as a spatial layer. For a spatial multiplexing multiple-input multiple-output MIMO system, a plurality of parallel data streams may be simultaneously transmitted on a same time-frequency resource, and each data stream is referred to as a transmission layer, a spatial layer, or a spatial stream. Generally, one DMRS port corresponds to one transmission layer, and each transmission layer corresponds to one data stream.

### 4. Channel Estimation

In a wireless communication system, to send and receive data, obtain system synchronization and feedback channel information, an uplink channel or a downlink channel needs to be estimated. In this application, channel estimation is a process of reconstructing or restoring a received signal to compensate for signal distortion caused by channel fading and noise, where time-domain and frequency-domain changes of a channel are tracked by using known standard signals of a transmitting end and a receiving end. The standard signal is also referred to as a pilot signal or a reference signal. The standard signals are distributed on different resource elements in time-frequency two-dimensional space in an OFDM symbol, and have a known amplitude and phase.

In a MIMO system, each transmit antenna (virtual antenna or physical antenna) has an independent channel. For example, in an uplink and a downlink, to implement channel quality measurement in a multi-antenna system, a plurality of pilot symbols are separately defined in an NR system: a CSI-RS, a DMRS, a sounding reference signal (SRS), and the like. The DMRS may be used to assist in demodulation of a physical downlink shared channel (PDSCH). The CSI-RS is used to measure a downlink channel corresponding to a physical antenna port. The receiving end performs channel estimation for a base station transmit antenna port, and performs channel state information (CSI) feedback by using an estimation result. The CSI may include a channel quality indicator (CQI), a precoding matrix indicator (PMI), a layer indicator (LI), a rank indicator (RI), or the like. However, in a measurement process of an uplink channel, a network device estimates the uplink channel by using a received SRS, and may perform frequency selection resource scheduling, power control, timing estimation and modulation/coding scheme order selection, downlink precoding generation in TDD, and the like based on the information.

### 5. MIMO Equalization

In a current MIMO system, a receiving end performs channel estimation on a time-frequency resource of a port, and determines an equalization coefficient (or referred to as an equalization matrix) based on an estimation result. The equalization coefficient is used to perform interference cancellation processing on a communication signal, to achieve better receiving performance. For example, based on the equalization coefficient, one of a plurality of transmission layers that are transmitted in parallel may be modeled as an interference signal, and one transmission layer may be modeled as a wanted signal, and impact of the interference signal on the wanted signal is eliminated at the receiving end via an equalizer. An optional interference cancellation manner is: performing a multiplication operation on a baseband signal of a receiving end antenna based on the equalization coefficient, where different antenna ports or receive channels are multiplied by different coefficients to cancel interference. The receiving end uses a signal obtained by performing the operation as a received baseband signal. In other words, the equalization coefficient is essentially a weighting coefficient. A first terminal apparatus may separately weight, based on a specific weighting coefficient, a signal received by each receive antenna of the first terminal apparatus, and finally combine these weighted signals to obtain data at a specific transmission layer.

For example, the receiving end uses minimum mean square error-interference rejection combining (MMSE-IRC) equalization. A weighting matrix (namely, an equalization coefficient) Wₖ^{H} of a user k satisfies:

Wₖ^{H}=(Iₖ+H_{eq,kk}^{H}·Rᵤᵤ⁻¹·H_{eq,kk})⁻¹H_{eq,kk}^{H}·Rᵤᵤ⁻¹∈ [symbol] ^{Nlayer}^{ₖ}^{×Nrx} (Formula 1), where
Iₖ represents an identity matrix; H_{eq,kk}^{H} represents a conjugate transpose matrix of an equivalent channel matrix H_{eq,kk} of data transmitted to the user k; Rᵤᵤ⁻¹ represents an inverse matrix of a noise interference channel covariance matrix Rᵤᵤ, and may be determined based on Rᵤᵤ; Nlayerₖ represents a quantity of transmission layers of the user k; and Nrx represents a quantity of receive antenna ports of the user k.

In addition, the noise interference channel covariance matrix Rᵤᵤ satisfies:

Rᵤᵤ=Σ_{l≠k}H_{eq,kl}·H_{eq,kl}^{H}+σ_{N}_{ₖ}²Iₖ∈ [symbol] ^{Nrx×Nrx}, where
l represents an interfering user l, and the interfering user l performs data transmission in parallel with the user k on a same time-frequency resource, causing interference to the user k;
H_{eq,kl} represents that an equivalent channel matrix is observed on the user k when the interfering user l performs data transmission; H_{eq,kl}^{H} represents a conjugate transpose matrix of a matrix H_{eq,kl}; and σ_{N}_{ₖ}² of represents noise power.

It may be understood that a dimension of a channel matrix H_{eq,kl}∈ [symbol] ^{Nrx×Nlayer}^{ₗ} is positively correlated with a quantity of parallel streams, where Nlayerₗ represents a quantity of transmission layers of the interfering user l.

In this case, as a quantity of receiving-end antenna ports continuously increases in a massive MIMO scenario and the like, although more scheduling layers and space domain resource distribution manners can be supported, the increasing quantity of antenna ports causes increasing channel processing complexity at the receiving end, and consequently, performance of the receiving end deteriorates. Application of increasing complexity at the receiving end includes: In an aspect, if an antenna port on which channel estimation needs to be performed cannot be properly determined, a strong interference source of a received signal is easily missed, and an accurate noise interference channel covariance matrix cannot be obtained through channel estimation, and interference cannot be suppressed by using an accurate equalization coefficient. Consequently, transmission quality deteriorates. In another aspect, if channel estimation is performed on all antenna ports, although deterioration of transmission performance is not caused, complexity in a channel estimation process greatly increases.

Embodiments of this application provides a communication method, to reduce complexity of channel measurement at a receiving end and improve performance of the receiving end.

The following describes the communication method by using an example in which a first terminal apparatus and a network device are execution bodies. It may be understood that the first terminal apparatus in this application may be a terminal device or a component in the terminal device.

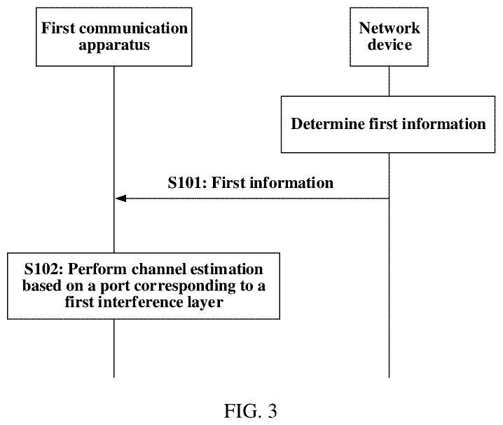

As shown in FIG. 3, a communication method provided in an embodiment of this application may include the following steps.

S101: A first terminal apparatus receives first information, where the first information indicates a port or ports corresponding to a first interference layer of the first terminal apparatus. The first interference layer is one or more interference layers in a plurality of interference layers of the first terminal apparatus, and the first interference layer is a transmission layer of a second terminal apparatus. For example, the second terminal apparatus includes a plurality of transmission layers, and the first interference layer is one or more transmission layers in the plurality of transmission layers. The second terminal apparatus may include one or more terminal devices, or may include a component in the one or more terminal devices. In this application, the first interference layer may also be referred to as a key interference layer.

It may be understood that the first information may be from a network device. For example, the first terminal apparatus is a receiving end, and the network device is a transmitting end. The first information may be determined or generated by the network device.

For example, it is assumed that the network device transmits data to a UE 1 and a UE 2 on a same time-frequency domain resource. The UE 1 and the UE 2 each have three transmission layers. For the UE 1, interference layers of the UE 1 include the three transmission layers of the UE 2, and a first interference layer of the UE 1 may be one or more transmission layers in the three transmission layers of the UE 2.

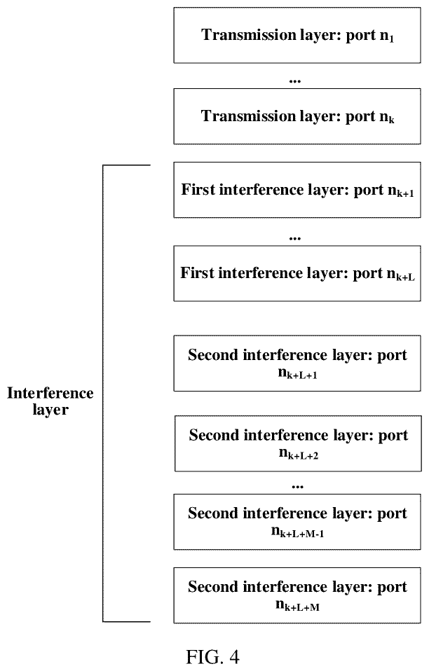

It may be understood that, in this application, a coupling term of the first interference layer of the first terminal apparatus between receive antennas greatly affects performance of MIMO equalization. In this case, ignoring measurement of the first interference layer greatly affects communication reliability. The coupling item is an element on a non-diagonal of a matrix H_{eq,kl}·H_{eq,kl}^{H}. In addition to the first interference layer, the plurality of interference layers of the first terminal apparatus may further include a second interference layer. The second interference layer has relatively weak interference energy. When the first terminal apparatus calculates a MIMO equalization coefficient, ignoring a channel estimation result of the second interference layer can significantly improve a throughput, and the performance of the MIMO equalization is not greatly affected, and therefore, reliability of communication performance is not greatly reduced. Optionally, as shown in FIG. 4, the second interference layer is an interference layer other than the first interference layer in the interference layers of the first terminal apparatus. In this application, interference energy may be energy that is of an interference layer and that is detected by a terminal apparatus or a transmission layer of the terminal apparatus. The second interference layer may alternatively be referred to as a non-key interference layer in this application.

In a possible example of determining the first interference layer and/or the second interference layer, the network device may determine the first interference layer and/or the second interference layer from the plurality of interference layers of the first terminal apparatus based on interference energy. Optionally, the interference energy may be determined based on a precoded equivalent channel matrix of the first terminal apparatus.

Optionally, in this application, interference energy of the first interference layer satisfies any one or more of the following conditions. Therefore, the first interference layer may be determined based on interference energy of an interference layer.
Condition 1: The interference energy of the first interference layer is higher than interference energy of the second interference layer.

For example, the interference energy of the first interference layer of the first terminal apparatus is at least higher than interference energy of at least one interference layer (referred to as the second interference layer) in all interference layers of the first terminal apparatus.

For example, the interference layers of the UE 1 include a transmission layer 1 to a transmission layer 3 of the UE 2, and interference energy of the transmission layer 1 to interference energy of the transmission layer 3 for the UE 1 are respectively represented as P1 to P3. If P1<P2<P3, for the UE 1, the transmission layer 2 and the transmission layer 3 of the UE 2 are the first interference layers of the UE 1, and the transmission layer 1 of the UE 2 is a second interference layer of the UE 1; or the transmission layer 3 of the UE 2 is the first interference layer of the UE 1, and the transmission layer 2 and the transmission layer 1 of the UE 2 are second interference layers of the UE 1.
Condition 2: The interference energy of the first interference layer is not less than an energy threshold (or referred to as a first threshold).

For example, an interference layer whose interference energy is not less than the first threshold in all interference layers of the first terminal apparatus may be used as the first interference layer. Similarly, an interference layer whose interference energy is less than the first threshold in all the interference layers of the first terminal apparatus may be used as the second interference layer.

For example, the interference layers of the UE 1 include a transmission layer 1 to a transmission layer 3 of the UE 2, and interference energy of the transmission layer 1 to interference energy of the transmission layer 3 for the UE 1 are respectively represented as P1 to P3. If P1<Pth, P2>Pth, and P3<Pth, where Pth represents the first threshold, for the UE 1, the transmission layer 2 of the UE 2 is the first interference layer of the UE 1, and the transmission layer 1 and the transmission layer 3 of the UE 2 are second interference layers of the UE 1.

Optionally, the first threshold may be determined based on total energy of all the interference layers of the first terminal apparatus and a specific proportion. For example, the first threshold may vary with the total energy of all the interference layers.
Condition 3: A proportion of the interference energy of the first interference layer in total interference energy of all interference layers of the first terminal apparatus is not less than a threshold (or referred to as a first proportion threshold).

For example, the total interference energy of all the interference layers may be determined based on interference energy of each interference layer of the first terminal apparatus, and a proportion of the interference energy of each interference layer in the total is determined based on the total and the interference energy of each interference layer. Further, an interference layer whose proportion of the interference energy is not less than the first proportion threshold may be used as the first interference layer.
Condition 4: The first interference layer includes a plurality of interference layers, and a sum of interference energy of the plurality of interference layers is not less than an energy threshold (or referred to as a second threshold, where the first threshold and the second threshold may be the same or different, and no specific requirement is imposed).

For example, the interference energy of the plurality of interference layers of the first terminal apparatus may be summed, and when the sum of the interference energy of the plurality of interference layers is not less than the second threshold, the plurality of interference layers are all used as the first interference layers.

Optionally, the second threshold may be determined based on total energy of all interference layers of the first terminal apparatus and a specific proportion. For example, the second threshold may vary with the total energy of all the interference layers.
Condition 5: The first interference layer includes a plurality of interference layers, and a proportion of a sum of interference energy of the plurality of interference layers in total interference energy of all interference layers of the first terminal apparatus is not less than a threshold (or referred to as a second proportion threshold, where the first proportion threshold and the second proportion threshold may be the same or different, and no specific requirement is imposed).

In a possible example, the first terminal apparatus may sort the plurality of interference layers in descending order of the interference energy, accumulate interference energy layer by layer starting from an interference layer with largest interference energy, and when a proportion of accumulated interference energy in the interference energy of all the interference layers exceeds the threshold, stop the accumulation, and use at least one selected interference layer as the first interference layer.

For example, the interference layers of the UE 1 are a transmission layer 1 to a transmission layer 3 of the UE 2, interference energy of the transmission layer 1 to interference energy of the transmission layer 3 for the UE 1 are respectively represented as P1 to P3, and the second proportion threshold is Rth. It is assumed that P1<P2<P3. If P2+P3>Rth*(P1+P2+P3) and P3<Rth*(P1+P2+P3), for the UE 1, the transmission layer 2 and the transmission layer 3 of the UE 2 are the first interference layers of the UE 1, and the transmission layer 1 of the UE 2 is a second interference layer of the UE 1.
Condition 6: The first interference layer is N interference layers with highest interference energy in the plurality of interference layers, where N is a positive integer.

For example, interference energy of the plurality of interference layers of the first terminal apparatus may be sorted in descending order, and the N interference layers with highest interference energy are used as the first interference layers.

It may be further understood that the foregoing conditions that the interference energy of the first interference layer satisfies are only examples for description. Any two or more of the foregoing conditions may be combined for implementation.

In this application, the interference energy of each interference layer may be determined based on all the interference layers of the first terminal apparatus. Correspondingly, a first interference layer determined based on the interference energy is a user-level first interference layer of the first terminal apparatus. The first interference layer may also be referred to as a user-level first interference layer determined at a space domain granularity, and is briefly referred to as the user-level first interference layer below. It may be understood that, for all transmission layers of the first terminal apparatus, first interference layers are the same.

In addition, the interference energy of each interference layer may alternatively be determined for each transmission layer of the first terminal apparatus. Correspondingly, a first interference layer determined based on the interference energy is a first interference layer corresponding to the transmission layer of the first terminal apparatus. Therefore, for different transmission layers of the first terminal apparatus, determined first interference layers may be different. The first interference layer may also be referred to as a layer-level first interference layer determined at a space domain granularity, and is briefly referred to as the layer-level first interference layer below.

The following separately describes manners of the user-level first interference layer and the layer-level first interference layer by using examples.
(1) For the user-level first interference layer, the network device may obtain the precoded equivalent channel matrix of the first terminal apparatus, determine interference energy of each of the plurality of interference layers of the first terminal apparatus based on a square of a 2-norm of a column vector corresponding to the interference layer in the precoded equivalent channel matrix, and determine the first interference layer based on the interference energy.

It is assumed that the network device transmits data to the UE 1 and the UE 2 on a same time-frequency domain resource, the UE 1 and the UE 2 each have three transmission layers, and the UE 1 has three receive antennas. In this case, a precoded equivalent channel matrix of the UE 1 may be represented as Table 1.

TABLE 1

| | Transmission | Transmission | Transmission | Transmission | Transmission | Transmission |
|---|---|---|---|---|---|---|
| | layer 1 of | layer 2 of | layer 3 of | layer 1 of | layer 2 of | layer 3 of |
| Coefficient | the UE 1 | the UE 1 | the UE 1 | the UE 2 | the UE 2 | the UE 2 |
| Receive | a11 | a12 | a13 | a14 | a15 | a16 |
| antenna 1 | | | | | | |
| of the UE 1 | | | | | | |
| Receive | a21 | a22 | a23 | a24 | a25 | a26 |
| antenna 2 | | | | | | |
| of the UE 1 | | | | | | |
| Receive | a31 | a32 | a33 | a34 | a35 | a36 |
| antenna 3 | | | | | | |
| of the UE 1 | | | | | | |

For example, interference energy of the interference layer of the UE 1 may be determined based on squares of 2-norms of column vectors corresponding to the transmission layer of the UE 2 in the equivalent channel matrix of the UE 1. In this application, the square of the 2-norm of the column vector in the precoded equivalent channel matrix means that the 2-norm of the column vector in the equivalent channel matrix is first obtained, and then, the square of the 2-norm is obtained.

For the UE 1, interference energy P4 of the transmission layer 1 of the UE 2 satisfies:

$$P 4 = abs ( a 14 ) * abs ( a 14 ) + abs ( a 24 ) * abs ( a 24 ) + abs ( a 34 ) * abs ( a 34 ) .$$

For the transmission layer 1 of the UE 2, column vectors include a14, a24, and a34, where a14, a24, and a34 respectively represent signals of the transmission layer 1 of the UE 2 that are received by the receive antenna 1, the receive antenna 2, and the receive antenna 3 of the UE 1.

Interference energy P5 of the transmission layer 2 of the UE 2 satisfies:

P5=abs(a15)*abs(a15)+abs(a25)*abs(a25)+abs(a35)*abs(a35).

For the transmission layer 2 of the UE 2, column vectors include a15, a25, and a35, where a15, a25, and a35 respectively represent signals of the transmission layer 2 of the UE 2 that are received by the receive antenna 1, the receive antenna 2, and the receive antenna 3 of the UE 1.

Interference energy P6 of the transmission layer 3 of the UE 2 satisfies:

$$P 6 = abs ( a 16 ) * abs ( a 16 ) + abs ( a 26 ) * abs ( a 26 ) + abs ( a 36 ) * abs ( a 36 ) .$$

For the transmission layer 3 of the UE 2, column vectors include a16, a26, and a36, where a16, a26, and a36 respectively represent signals of the transmission layer 3 of the UE 2 that are received by the receive antenna 1, the receive antenna 2, and the receive antenna 3 of the UE 1.

In this application, abs(x) represents an absolute value of x, and * represents a multiplication operation.

Further, the network device may determine the first interference layer of the UE 1 based on the interference energy of the interference layer. For example, the network device may determine the first interference layer of the UE 1 based on Condition 1 to Condition 6.
(2) For the layer-level first interference layer, the network device may determine an end-to-end equivalent channel matrix of the UE 1 based on the precoded equivalent channel matrix of the first terminal apparatus and an equalization coefficient matrix of the UE 1, and then determine the first interference layer based on the end-to-end equivalent channel matrix of the UE 1.

The following describes a manner of determining the first interference layer at a layer-level granularity.

For example, the network device may obtain an equalization coefficient matrix indicated by the network device. The equalization coefficient matrix is generated by the network device in a default manner. For example, a channel estimation result used to generate the equalization coefficient matrix is determined based on ports of all the interference layers. The network device may determine the layer-level first interference layer based on the equalization coefficient matrix. For example, the equalization coefficient matrix determined by the network device is shown in Table 2.

TABLE 2

| | Receive antenna | Receive antenna | Receive antenna |
|---|---|---|---|
| | 1 of the UE 1 | 2 of the UE 1 | 3 of the UE 1 |
| Transmission layer | w11 | w12 | w13 |
| 1 of the UE 1 | | | |
| Transmission layer | w21 | w22 | w23 |
| 2 of the UE 1 | | | |
| Transmission layer | w31 | w32 | w33 |
| 3 of the UE 1 | | | |

A multiplication operation is performed on the equalization coefficient matrix shown in Table 2 and the equivalent channel matrix of the UE 1 shown in Table 1, to obtain the end-to-end equivalent channel matrix of the UE 1, as shown in Table 3.

TABLE 3

| | Transmission | Transmission | Transmission | Transmission | Transmission | Transmission |
|---|---|---|---|---|---|---|
| | layer 1 of | layer 2 of | layer 3 of | layer 1 of | layer 2 of | layer 3 of |
| | the UE 1 | the UE 1 | the UE 1 | the UE 2 | the UE 2 | the UE 2 |
| Transmission | w11*a11 + | w11*a12 + | w11*a13 + | w11*a14 + | w11*a15 + | w11*a16 + |
| layer 1 of | w12*a21 + | w12*a22 + | w12*a23 + | w12*a24 + | w12*a25 + | w12*a26 + |
| the UE 1 | W13*a31 | W13*a32 | W13*a33 | W13*a34 | W13*a35 | W13*a36 |
| Transmission | w21*a11 + | w21*a12 + | w21*a13 + | w21*a14 + | w21*a15 + | w21*a16 + |
| layer 2 of | w22*a21 + | w22*a22 + | w22*a23 + | w22*a24 + | w22*a25 + | w22*a26 + |
| the UE 1 | W23*a31 | W23*a32 | W23*a33 | W23*a34 | W23*a35 | W23*a36 |
| Transmission | w31*a11 + | w31*a12 + | w31*a13 + | w31*a14 + | w31*a15 + | w31*a16 + |
| layer 3 of | w32*a21 + | w32*a22 + | w32*a23 + | w32*a24 + | w32*a25 + | w32*a26 + |
| the UE 1 | W33*a31 | W33*a32 | W33*a33 | W33*a34 | W33*a35 | W33*a36 |

Optionally, a possible manner of determining the first interference layer based on the end-to-end equivalent channel matrix is: determining interference energy of all the interference layers of the UE 1 (to be specific, the transmission layer 1, the transmission layer 2, and the transmission layer 3 of the UE 2) for each transmission layer of the UE 1 based on the end-to-end equivalent channel matrix, and determining, from the transmission layers of the UE 2, a first interference layer of each transmission layers of the UE 1 based on the interference energy.

As shown in Table 3, interference energy generated by the transmission layer 1 of the UE 2 for the transmission layer 1 of the UE 1 may be represented as a square of a 2-norm of (w11*a14+w12*a24+W13*a34).

Further, the network device may determine the first interference layer of each transmission layer of the UE 1 based on the interference energy of the interference layer. For example, the network device may determine the first interference layer of each transmission layer of the UE 1 based on Condition 1 to Condition 6.

It may be understood that Condition 1 to Condition 6 are described by using the interference energy of the interference layer for the first terminal apparatus as an example. If the interference energy is interference energy for each transmission layer of the first terminal apparatus, similar processing may be performed with reference to Condition 1 to Condition 6, to determine a first interference layer of each transmission layer. For example, in Condition 1, if P1 to P3 respectively represent the interference energy of the transmission layer 1 of the UE 2 to interference energy of the transmission layer 3 of the UE 2 for the transmission layer 1 of the UE 1, and P1<P2<P3, for the transmission layer 1 of the UE 1, the transmission layer 2 and the transmission layer 3 of the UE 2 are first interference layers of the transmission layer 1 of the UE 1, and the transmission layer 1 of the UE 2 is a second interference layer of the transmission layer 1 of the UE 1.

Optionally, in another possible manner of determining the first interference layer corresponding to the transmission layer of the UE 1, for example, absolute values of matrix vectors of the transmission layer 1, the transmission layer 2, and the transmission layer 3 of the UE 2 separately corresponding to the transmission layer 1 of the UE 1 in Table 3 are compared, to reflect a magnitude of energy of interference caused by each of the transmission layer 1, the transmission layer 2, and the transmission layer 3 of the UE 2 to the transmission layer 1 of the UE 1. The first interference layer and/or the second interference layer are/is determined based on a comparison result.

For example, if the matrix vector (w11*a14+w12*a24+W13*a34) of the transmission layer 1 of the UE 2 corresponding to the transmission layer 1 of the UE 1, the matrix vector (w11*a15+w12*a25+W13*a35) of the transmission layer 2 of the UE 2 corresponding to the transmission layer 1 of the UE 1, and the matrix vector (w11*a16+w12*a26+W13*a36) of the transmission layer 3 of the UE 2 corresponding to the transmission layer 1 of the UE 1 satisfy:

$$abs ( w 11 * a 14 + w 12 * a 24 + W 13 * a 34 ) > abs ( w 11 * a 15 + w 12 * a 25 + W 13 * a 35 ) > abs ( w 11 * a 16 + w {12}^{*} a 26 + W 13 * a 36 ) ,$$

for the transmission layer 1 of the UE 1, if a quantity of first interference layers is required to be 1, the first interference layer may be the transmission layer 1 of the UE 2; or if a quantity of first interference layers is required to be 2, the first interference layers may be the transmission layer 1 and the transmission layer 2 of the UE 2.

For another example, if the matrix vector (w21*a14+w22*a24+W23*a34) of the transmission layer 1 of the UE 2 corresponding to the transmission layer 2 of the UE 1, the matrix vector (w21*a15+w22*a25+W23*a35) of the transmission layer 2 of the UE 2 corresponding to the transmission layer 2 of the UE 1, and the matrix vector (w21*a16+w22*a26+W23*a36) of the transmission layer 3 of the UE 2 corresponding to the transmission layer 2 of the UE 1 satisfy:

$$abs ( w 21 * a 14 + w 22 * a 24 + W 23 * a 34 ) > abs ( w 21 * a 15 + w 22 * a 25 + W 23 * a 35 ) > abs ( w 21 * a 16 + w {22}^{*} a 26 + W 23 * a 36 ) ,$$

for the transmission layer 2 of the UE 1, if a quantity of first interference layers is required to be 1, the first interference layer may be the transmission layer 1 of the UE 2; or if a quantity of first interference layers is required to be 2, the first interference layers may be the transmission layer 1 and the transmission layer 2 of the UE 2.

For another example, if the matrix vector (w31*a14+w32*a24+W33*a34) of the transmission layer 1 of the UE 2 corresponding to the transmission layer 3 of the UE 1, the matrix vector (w31*a15+w32*a25+W33*a35) of the transmission layer 2 of the UE 2 corresponding to the transmission layer 3 of the UE 1, and the matrix vector (w31*a16+w32*a26+W33*a36) of the transmission layer 3 of the UE 2 corresponding to the transmission layer 3 of the UE 1 satisfy:

$$abs ( w 31 * a 14 + w 32 * a 24 + W 33 * a 34 ) > abs ( w 31 * a 15 + w 32 * a 25 + W 33 * a 35 ) > abs ( w 31 * a 16 + w {32}^{*} a 26 + W 33 * a 36 ) ,$$

for the transmission layer 3 of the UE 1, if a quantity of first interference layers is required to be 1, the first interference layer may be the transmission layer 1 of the UE 2; or if a quantity of first interference layers is required to be 2, the first interference layers may be the transmission layer 1 and the transmission layer 2 of the UE 2.

Optionally, the first interference layer may be further obtained through classification at a frequency-domain granularity. In other words, the first interference layer of the first terminal apparatus may be determined at the frequency-domain granularity.

In terms of the frequency-domain granularity, the first interference layer may be obtained classification in an RB level, a full band level, and a sub-band level. Table 1 is used as an example. The RB level means that the coefficients (a14 to a36 shown in Table 1) in the equivalent channel matrix are obtained through RB-level statistics collection. The full band level means that the coefficients (a14 to a36 shown in Table 1) in the equivalent channel matrix are obtained through full band-level statistics collection, where one full band may include several sub-bands or RBs. The sub-band level means that the coefficients (a14 to a36 shown in Table 1) in the equivalent channel matrix are obtained through sub-band-level statistics collection, where one sub-band may include a plurality of RBs.

In S101, the first information may include at least one of indication information of the port corresponding to the first interference layer, indication information of a port corresponding to the second interference layer, and indication information of a port group.

The following separately describes content that may be included in the first information.

In a possible implementation, the first information may include the indication information of the port corresponding to the first interference layer and/or the indication information of the port corresponding to the second interference layer, and the second interference layer does not include the first interference layer. In this application, indication information of a port may include a port index.

According to this implementation, when the first information includes the indication information of the port corresponding to the first interference layer, the first information may directly indicate (or explicitly indicate) the port corresponding to the first interference layer.

In a possible implementation, the first information may include the information about the port group, for example, a DMRS pattern indication, implicitly indicating the first interference layer and/or the second interference layer. Correspondingly, the first terminal apparatus may determine the first interference layer and/or the second interference layer based on information about a port in the port group and a port of to-be-transmitted data of the first terminal apparatus.

The information about the port group may include information about the port in the port group. The first terminal apparatus may determine, based on a port used by the first terminal apparatus to receive data and the information about the port in the port group, the port corresponding to the first interference layer and/or the port corresponding to the second interference layer.

A main principle of DMRS design is as follows: DMRS ports of transmission layers of two UEs that strongly interfere with each other mainly use exclusive time-frequency resources, and DMRS ports of transmission layers of two UEs that weakly interfere with each other mainly use shared time-frequency resources. In this way, high pilot density for strong interference and low pilot density for weak interference are implemented, and DMRS overheads are reduced.

For example, a transmission layer 1 of a user 1 is a first interference layer of a user 2, and a transmission layer 1 of a user 2 is a second interference layer of the user 1. Transmission layers of different users that are second interference layers of each other may correspond to a same time-frequency resource, in other words, may correspond to ports in a same port group. Transmission layers of different users that are second interference layers of each other correspond to different time-frequency resources, in other words, correspond to ports in different port groups. After determining, based on the port of the to-be-transmitted data of the first terminal apparatus and the information about the port group, a port group to which the port of the to-be-transmitted data of the first terminal apparatus belongs, the first terminal apparatus may determine that another port in the same port group is the port corresponding to the first interference layer, and/or may determine that a port in a different port group is the port corresponding to the second interference layer.

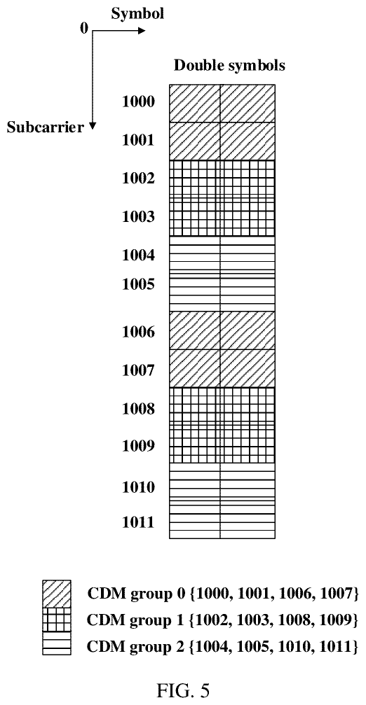

As shown in FIG. 5, a configuration of a DMRS port of a type-2 (Type 2) double-OFDM symbol type is used as an example. DMRS ports are divided into three DMRS port groups, where a first DMRS port group includes a port 1000, a port 1001, a port 1006, and a port 1007, a second DMRS port group includes a port 1002, a port 1003, a port 1008, and a port 1009, and a third DMRS port group includes a port 1004, a port 1005, a port 1010, and a port 1011. Ports in a same DMRS port group share a same time-frequency resource. It may be understood that, in FIGS. 5, 1000, 1001, . . . , and 1011 are port indexes respectively.

It is assumed that the network device transmits data to the UE 1 and the UE 2 on a same time-frequency domain resource, and the UE 1 and the UE 2 each have three transmission layers. Table 4 provides a first interference layer of each transmission layer of the UE 1 and each transmission layer of the UE 2 from a perspective of the layer-level first interference layer.

TABLE 4

| | Interference layer | | | | | |
|---|---|---|---|---|---|---|
| | Transmission | Transmission | Transmission | Transmission | Transmission | Transmission |
| | layer 1 of | layer 2 of | layer 3 of | layer 1 of | layer 2 of | layer 3 of |
| Interfered layer | the UE 1 | the UE 1 | the UE 1 | the UE 2 | the UE 2 | the UE 2 |
| Transmission | N/A | N/A | N/A | First | Second | Second |
| layer 1 of | | | | interference | interference | interference |
| the UE 1 | | | | layer | layer | layer |
| Transmission | N/A | N/A | N/A | First | Second | Second |
| layer 2 of | | | | interference | interference | interference |
| the UE 1 | | | | layer | layer | layer |
| Transmission | N/A | N/A | N/A | First | Second | Second |
| layer 3 of | | | | interference | interference | interference |
| the UE 1 | | | | layer | layer | layer |
| Transmission | First | Second | Second | N/A | N/A | N/A |
| layer 1 of | interference | interference | interference | | | |
| the UE 2 | layer | layer | layer | | | |
| Transmission | First | Second | Second | N/A | N/A | N/A |
| layer 2 of | interference | interference | interference | | | |
| the UE 2 | layer | layer | layer | | | |
| Transmission | First | Second | Second | N/A | N/A | N/A |
| layer 3 of | interference | interference | interference | | | |
| the UE 2 | layer | layer | layer | | | |

It can be learned from the foregoing table that, the transmission layer 1 of the UE 1 and the transmission layer 1 of the UE 2 are first interference layers of each other, the transmission layer 2 of the UE 1 and each of the transmission layer 2 of the UE 2 and the transmission layer 3 of the UE 2 are second interference layers of each other, and the transmission layer 3 of the UE 1 and each of the transmission layer 2 of the UE 2 and the transmission layer 3 of the UE 2 are second interference layers of each other.

Optionally, the network device may configure, as transmission layers corresponding to ports in a same DMRS port group, transmission layers that are second interference layers of each other and that are in the transmission layers of each of the UE 1 and the UE 2, and allocate, as transmission layers corresponding to ports in different DMRS port groups, transmission layers that are first interference layers of each other, to avoid transmission interference between the transmission layers that are first interference layers of each other. Optionally, the network device may further include, in the first information, a correspondence between transmission layers of each of the UE 1 and the UE 2 and the ports in the DMRS port groups. For example, the correspondence is shown in Table 5.

TABLE 5

| Transmission layer | Allocated DMRS port |
|---|---|
| Transmission layer 1 of the UE 1 | Port 1000 |
| Transmission layer 2 of the UE 1 | Port 1004 |
| Transmission layer 3 of the UE 1 | Port 1005 |
| Transmission layer 1 of the UE 2 | Port 1002 |
| Transmission layer 2 of the UE 2 | Port 1010 |
| Transmission layer 3 of the UE 2 | Port 1011 |

As shown in Table 4, because the transmission layer 1 of the UE 1 and the transmission layer 1 of the UE 2 are first interference layers of each other, in Table 5, the network device may configure the transmission layer 1 of the UE 1 as a transmission layer corresponding to the port 1000, and configure the transmission layer 1 of the UE 2 as a transmission layer corresponding to the port 1002. According to a DMRS port configuration solution shown in FIG. 5, the port 1000 and the port 1002 correspond to different time-frequency resources, to be specific, the port 1000 and the port 1002 do not share a time-frequency resource, to avoid mutual interference. In addition, the transmission layer 2 of the UE 1 and the transmission layer 2 of the UE 2 are second interference layers of each other. According to Table 5 and FIG. 5, the port 1004 and the port 1010 corresponding to the two transmission layers belong to the same DMRS port group, in other words, share a same time-frequency resource. Table 5 is used as an example. If receiving data through the port 1000, the first terminal apparatus may determine, according to FIG. 5, that the port 1000 and the port 1001, the port 1006, and the port 1007 belong to the same DMRS port group. Therefore, the port 1001, the port 1006, and the port 1007 are used as ports corresponding to the first interference layer. In addition, the first terminal apparatus may further use the port 1002, the port 1003, the port 1004, the port 1005, the port 1008, the port 1009, the port 1010, and the port 1011 as ports corresponding to the second interference layer.

In another possible implementation, the first information may include information about the port group, and at least one of the indication information of the port corresponding to the first interference layer and/or the indication information of the port corresponding to the second interference layer.

In this implementation, when the indication information of the port corresponding to the first interference layer and/or the indication information of the port corresponding to the second interference layer do/does not indicate that an interference layer is the first interference layer or an interference layer is the second interference layer, the first terminal device determines, based on the information about the port group, whether the interference layer is the first interference layer or the interference layer is the second interference layer.

For example, according to Table 5, if receiving data through the port 1000, the first terminal apparatus may use, according to FIG. 5, the port 1001, the port 1006, and the port 1007 as ports corresponding to the first interference layer. If the first information further includes the indication information of the port corresponding to the first interference layer, where the indication information indicates to use the port 1002 as the port corresponding to the first interference layer, the first terminal apparatus may use the port 1001, the port 1002, the port 1006, and the port 1007 as ports corresponding to the first interference layer.

S102: The first terminal apparatus performs channel estimation based on the port corresponding to the first interference layer.

In a possible implementation of S102, the first terminal apparatus may perform channel estimation based on a first time-frequency resource. The first time-frequency resource corresponds to the port corresponding to the first interference layer, in other words, the first time-frequency resource is a time-frequency resource corresponding to the port corresponding to the first interference layer.

Optionally, the first terminal apparatus may perform channel estimation based on the first time-frequency resource, and a time-frequency resource corresponding to noise and/or a time-frequency resource corresponding to the to-be-transmitted data of the first terminal apparatus. In this application, a result of the channel estimation may be used to determine an equalization coefficient. The first terminal apparatus may receive data based on the equalization coefficient.

In this application, unless otherwise specified, the to-be-transmitted data of the first terminal apparatus is received data of the first terminal apparatus.

In other words, in this application, the first terminal apparatus may perform channel measurement on the port indicated by the first information. In this way, it is less difficult for the first terminal apparatus to determine, from a plurality of ports, a port on which channel estimation needs to be performed, thereby reducing processing complexity at the receiving end, and improving performance of the receiving end.

Further, optionally, if the port corresponding to the first interference layer is a part of ports corresponding to all the interference layers of the first terminal apparatus, in other words, the first terminal apparatus does not need to perform channel estimation on a time-frequency resource corresponding to another part of the ports (for example, a port corresponding to the second interference layer, or a part of the ports corresponding to the second interference layer). Therefore, complexity of the channel estimation at the receiving end can be further reduced.

It may be understood that a minimum unit of a time-frequency resource for performing channel estimation may be an RE.

Optionally, a time-frequency resource on which the first terminal apparatus needs to perform estimation includes at least one of the following:
(1) First time-frequency resource, to be specific, the time-frequency resource corresponding to the port corresponding to the first interference layer.

The first terminal apparatus may perform channel estimation on the first time-frequency resource to obtain an interference estimation result of the port corresponding to the first interference layer, and then obtain a noise interference channel covariance matrix (briefly referred to as a channel covariance matrix below) based on the interference estimation result. The channel covariance matrix may be used to determine the equalization coefficient. It may be understood that the first time-frequency resource may be determined based on a port configuration. For example, the first terminal apparatus may determine, based on first indication information, the port corresponding to the first interference layer, and may further determine, based on a port configuration, the time-frequency resource corresponding to the port. The port configuration may include a DMRS port configuration, and the configuration of the DMRS port of the type-2 double-OFDM symbol type is shown in FIG. 5.

When there is only one first interference layer, the channel covariance matrix may be obtained by using an exclusion method.

Optionally, an example of the exclusion method is as follows:

The receiving end first estimates an equivalent channel matrix H_{eq,kk} of transmitted data of a user k, obtains an estimated Ĥ_{eq,kk} of the equivalent channel matrix, and then obtains an estimated \hat{R}ᵤᵤ of a channel covariance matrix Rᵤᵤ by using an exclusion method:

$${\hat{R}}_{uu} = \frac{1}{N pilot} ( {Y}_{k , pilot} - {\hat{H}}_{eq , kk} \cdot {X}_{k , pilot} ) \cdot {( {Y}_{k , pilot} - {\hat{H}}_{eq , kk} \cdot {X}_{k , pilot} )}^{H} \approx {R}_{uu} ,$$

where
Y_{k,pilot} represents a received signal sequence, H_{eq,kk} represents the estimation of the equivalent channel matrix H_{eq,kk} of the transmitted data of the user k, Y_{k,pilot}∈ [symbol] ^{Nrx×Npilot}, a user sequence X_{k,pilot}∈ [symbol] ^{Nlayer}^{ₖ}^{×Npilot}, Npilot represents a quantity of antennas for transmitting a pilot signal, Nrx represents a quantity of receive antenna ports of the user k, and Nlayerₖ represents a quantity of transmission layers of the user k.

The first terminal apparatus may alternatively process the interference estimation result of the first interference layer in another manner. In other words, the interference estimation result of the first interference layer cannot be ignored in a process of determining the equalization coefficient. For example, ignoring interference DMRS PORT or using power estimation of the interference DMRS PORT may cause a throughput loss.
(2) Time-frequency resource corresponding to the port corresponding to the second interference layer, where for ease of description, the time-frequency resource is referred to as a second time-frequency resource below.

When determining composition of a noise interference channel covariance matrix, the first terminal apparatus does not consider (or ignore) an interference measurement result of the second time-frequency resource, or may ignore performing channel estimation on the second time-frequency resource.

Optionally, the UE may alternatively process the second time-frequency resource in another manner, for example, perform channel estimation on some or all second time-frequency resources, to improve accuracy of the channel covariance matrix. However, processing complexity is increased, and a throughput loss is caused.
(3) Time-frequency resource that includes noise.

For a time-frequency resource including only pure noise (to be specific, not including the time-frequency resource corresponding to the port corresponding to the first interference layer and the time-frequency resource corresponding to the port corresponding to the second interference layer), the first terminal apparatus may perform channel estimation on the time-frequency resource, and determine the channel covariance matrix based on an estimation result.

Channel estimation is performed on a time-frequency resource including the time-frequency resource of the to-be-transmitted data of the first terminal apparatus and the pure noise, or on a time-frequency resource including the first time-frequency resource and the noise, or on a time-frequency resource including the time-frequency resource of the to-be-transmitted data of the first terminal apparatus, the first time-frequency resource, and the noise, to obtain the channel covariance matrix.

In addition, the first terminal apparatus performing noise estimation by using another RE is not excluded in this application, for example, performing measurement on an RE that includes a second time-frequency resource and the noise. However, processing complexity increases, and a throughput loss is caused.

Optionally, based on different types of time-frequency resources on which estimation needs to be performed, a manner in which the first terminal apparatus performs estimation on a time-frequency resource is shown in Table 6. Any type of time-frequency resource may include one or more of the noise (or the time-frequency resource including the noise), the first time-frequency resource, the second time-frequency resource, and the time-frequency resource of the to-be-transmitted data of the first terminal apparatus. Therefore, in Table 6, one or more of the noise, the first time-frequency resource, the second time-frequency resource, and the time-frequency resource of the to-be-transmitted data of the first terminal apparatus represent the type of the time-frequency resource, to be specific, represent that one or more of the noise, the first time-frequency resource, the second time-frequency resource, and the time-frequency resource of the to-be-transmitted data of the first terminal apparatus are included in the time-frequency resource. The first time-frequency resource may correspond to one or more first interference layers. Therefore, the first time-frequency resource includes a first time-frequency resource corresponding to a single first interference layer and first time-frequency resources corresponding to a plurality of first interference layers. Similarly, the second time-frequency resource includes a second time-frequency resource corresponding to a single second interference layer and second time-frequency resources corresponding to a plurality of second interference layers.

TABLE 6

| Processing | Time-frequency | Recommended processing method and step of the first |
|---|---|---|
| manner | resource type | terminal apparatus |
| 1 | Noise | Perform noise power estimation to obtain a corresponding |
| Processing | Time-frequency | Recommended processing method and step of the first |
| manner | resource type | terminal apparatus |
| | | covariance matrix; |
| 2 | Noise, and time- | (1) Perform channel estimation on the time-frequency |
| | frequency resource | resource of the to-be-transmitted data of the first terminal |
| | of the to-be- | apparatus, to obtain a corresponding covariance matrix; and |
| | transmitted data of | (2) obtain, based on an estimation result of the time- |
| | the first terminal | frequency resource of the to-be-transmitted data by using an |
| | apparatus | exclusion method, a channel estimation result of a resource |
| | | including the noise, and obtain a corresponding covariance |
| | | matrix; |
| 3 | Noise, and first | Perform joint channel estimation based on the first time- |
| | time-frequency | frequency resource and a resource including the noise, to |
| | resource | obtain a corresponding covariance matrix |
| | corresponding to | |
| | the single first | |
| | interference layer | |
| 3.1 | Noise, and first | (1) Perform channel estimation on the first time-frequency |
| | time-frequency | resources one by one to obtain a corresponding covariance |
| | resources | matrix; and |
| | corresponding to | (2) perform joint channel estimation on one remaining first |
| | the plurality of | time-frequency resource and a resource including the noise, |
| | first interference | to obtain a corresponding covariance matrix. |
| | layers | For example, it is assumed that three first interference layers |
| | | are included, and a received signal |
| | | r = H1*x1 + H2*x2 + H3*x3 + n, where n is the noise; x1, x2, |
| | | and x3 are DMRS signals of three transmission layers |
| | | respectively; and H1, H2, and H3 respectively represent |
| | | channels of the three transmission layers. Channel estimation |
| | | is performed by using r to obtain H1 and H2 in sequence, and |
| | | a channel covariance matrix Ruu = H1*CT(H1) + H2*CT(H2) |
| | | is obtained, where CT( ) represents performing conjugate |
| | | transposition; |
| | | and after Ruu is obtained in step (1), addition needs to be |
| | | performed on Ruu and the covariance matrix obtained in step |
| | | (2). |
| 4 | Noise, and second | No processing, to be specific, channel estimation is not |
| | time-frequency | performed. |
| | resources | |
| | corresponding to | |
| | the plurality of | |
| | second | |
| | interference layers | |
| 5 | Noise, time- | (1) Perform channel estimation on the time-frequency |
| | frequency resource | resource of the to-be-transmitted data of the first terminal |
| | of the to-be- | apparatus, to obtain a corresponding covariance matrix; |
| | transmitted data of | (2) perform channel estimation on the first time-frequency |
| | the first terminal | resources one by one to obtain a corresponding covariance |
| | apparatus, and first | matrix; and |
| | time-frequency | (3) perform joint channel estimation on one remaining first |
| | resource | time-frequency resource and a resource including the noise, |
| | | to obtain a corresponding covariance matrix |
| 6 | Noise, time- | (1) Perform channel estimation on the time-frequency |
| | frequency resource | resource of the to-be-transmitted data of the first terminal |
| | of the to-be- | apparatus, to obtain a corresponding covariance matrix; and |
| | transmitted data of | (2) not perform channel estimation on a resource including |
| | the first terminal | the noise and the second time-frequency resource. |
| | apparatus, and | In addition, it may be assumed that the noise is stationary. |
| | second time- | Therefore, a noise estimation result estimated on another |
| | frequency resource | time-frequency resource may be used. |
| 7 | Noise, first time- | (1) Perform channel estimation on the first time-frequency |
| | frequency | resource to obtain a corresponding covariance matrix; and |
| | resource, and | (2) not perform channel estimation on a resource including |
| | second time- | the noise and the second time-frequency resource. |
| | frequency resource | |
| 8 | Noise, time- | (1) Perform channel estimation on the time-frequency |
| | frequency resource | resource of the to-be-transmitted data of the first terminal |
| | of the to-be- | apparatus, to obtain a corresponding covariance matrix; |
| | transmitted data of | (2) perform channel estimation on the first time-frequency |
| | the first terminal | resource to obtain a corresponding covariance matrix; and |
| | apparatus, first | (3) not perform channel estimation on a resource including |
| | time-frequency | the noise and the second time-frequency resource. |
| | resource, and | |
| | second time- | |
| | frequency resource | |

According to Table 6, MMSE-IRC equalization is used as an example, a channel covariance matrix Rᵤᵤ satisfies:

$${R}_{uu} {H}_{eq , kk} \cdot {H}_{eq , kk}^{H} + \{ {\sum }_{l 1 \neq k} {H}_{eq , kl 1} \cdot {H}_{eq , kl 1}^{H} + {\sum }_{l 2 \neq k , l 2 \neq l 1} {H}_{eq , kl 2} \cdot {H}_{eq , kl 2}^{H} + {σ}_{{N}_{k}}^{2} {I}_{k} \} ,$$

where
H_{eq,kk}·H_{eq,kk} is a covariance matrix obtained by performing channel estimation on the H time-frequency resource of the to-be-transmitted data of the first terminal apparatus, H_{eq,kk} represents an equivalent channel matrix of the data transmitted to the user k, and H_{eq,kk} is a conjugate transpose matrix of H_{eq,kk}; Σ_{l1≠k}H_{eq,kl1}^{H} is a corresponding covariance matrix obtained by performing channel estimation on the time-frequency resource corresponding to the first interference layer, H_{eq,kl1} represents an equivalent channel matrix of the data transmitted to the user k and a user l1, and H_{eq,kl1}^{H} is a conjugate transpose matrix of H_{eq,kl1}; Σ_{l2≠k,l2≠l1}H_{eq,kl2}·H_{eq,kl2}^{H} is a covariance matrix obtained by performing channel estimation on the time-frequency resource corresponding to the second interference layer, H_{eq,kl2} represents an equivalent channel matrix of data transmitted to the user k and a user l2, and H_{eq,kl2}^{H} is a conjugate transpose matrix of H_{eq,kl2}, where l2≠l1; and σ_{N}_{ₖ}²Iₖ represents a covariance matrix corresponding to the noise.

It may be understood that, if the estimation of the second interference layer is ignored, the channel covariance matrix Rᵤᵤ satisfies:

$${R}_{uu} {H}_{eq , kk} \cdot {H}_{eq , kk}^{H} + \{ {\sum }_{l 1 \neq k} {H}_{eq , kl 1} \cdot {H}_{eq , kl 1}^{H} + {σ}_{{N}_{k}}^{2} {I}_{k} \} .$$

Based on the channel covariance matrix Rᵤᵤ, the network device may determine an equalization coefficient Wₖ^{H} of the user k. A manner in which the network device determines the equalization coefficient Wₖ^{H} of the user k based on the channel covariance matrix Rᵤᵤ is not specifically limited in this application. In a possible determining manner, the network device determines the equalization coefficient Wₖ^{H} of the user k based on the foregoing Formula 1.

It may be understood that the formula that the channel covariance matrix Rᵤᵤ satisfies is an example, and should not be used as a limitation on the channel covariance matrix Rᵤᵤ. For example, there may be another variation based on an equalization method and an actual application scenario.

Optionally, in this application, a second communication apparatus may further send second information to the first terminal apparatus. The second information may be used to indicate, notify, or configure the first terminal apparatus to perform the communication method provided in this embodiment of this application. Correspondingly, the first terminal apparatus performs the method shown in FIG. 3. For example, the second information may indicate the first terminal apparatus to perform compact interference channel estimation (CICE). In this case, the first terminal apparatus may perform, based on the second information, the method provided in this embodiment of this application.

It may be understood that, to implement functions in the foregoing embodiments, an embodiment of this application further provides a communication apparatus. The communication apparatus may include a corresponding hardware structure and/or software module for performing the functions. Persons skilled in the art should be easily aware that, with reference to the units and the method steps in the examples described in embodiments disclosed in this application, this application can be implemented by using hardware or a combination of hardware and computer software. Whether a function is performed by hardware or hardware driven by computer software depends on particular application scenarios and design constraints of the technical solutions.

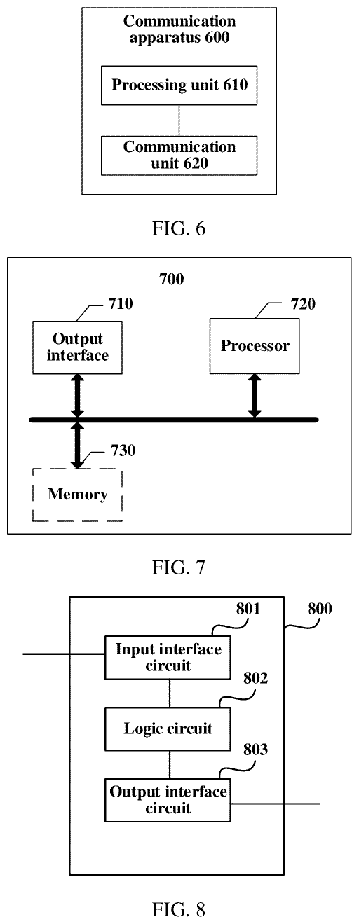

FIG. 6 to FIG. 8 are diagrams of structures of possible communication apparatuses according to embodiments of this application. The communication apparatuses may be configured to implement functions of the network device or the first terminal apparatus in the foregoing method embodiment, and therefore can also implement beneficial effects of the foregoing method embodiment. In a possible implementation, the communication apparatus may be any network device or first terminal apparatus shown in FIG. 1 to FIG. 3. For related details and effect, refer to the descriptions in the foregoing embodiments.

As shown in FIG. 6, a communication apparatus 600 includes a processing unit 610 and a communication unit 620, where the communication unit 620 may be a transceiver unit, an input/output interface, or the like. The communication apparatus 600 may be configured to implement functions of the network device or the first terminal apparatus in the method embodiment shown in FIG. 3.

Optionally, when implementing the functions of the first terminal apparatus, the communication unit 620 may be configured to receive first information, where the first information indicates a port corresponding to a first interference layer of the first terminal apparatus, the first interference layer is one or more interference layers in a plurality in interference layers of the first terminal apparatus, and the first interference layer is a transmission layer of a second terminal apparatus. The processing unit 610 may be configured to perform channel estimation based on the port corresponding to the first interference layer.

Optionally, the processing unit 610 may be further configured to: determine an equalization coefficient based on a result of the channel estimation, and receive data based on the equalization coefficient.

Optionally, the processing unit 610 may be specifically configured to perform channel estimation based on a first time-frequency resource, where the first time-frequency resource corresponds to the port corresponding to the first interference layer.

Optionally, the processing unit 610 may be specifically configured to perform channel estimation based on the first time-frequency resource and a time-frequency resource corresponding to noise and/or a time-frequency resource corresponding to to-be-transmitted data.

Optionally, when the first information further includes indication information of a port group, the processing unit 610 may be further configured to determine, based on a port corresponding to the to-be-transmitted data and a port in the port group, and indication information of the port corresponding to the first interference layer and/or indication information of a port corresponding to a second interference layer, the port corresponding to the first interference layer, where the second interference layer does not include the first interference layer.

Optionally, when the first information includes the indication information of the port group, the processing unit 610 may be further configured to determine, based on the port corresponding to the to-be-transmitted data and the port in the port group, the port corresponding to the first interference layer.

Optionally, when implementing the functions of the first terminal apparatus, the processing unit 610 may be configured to determine first information, where the first information indicates a port corresponding to a first interference layer of the first terminal apparatus, the first interference layer is one or more interference layers in a plurality of interference layers of the first terminal apparatus, and the first interference layer is a transmission layer of a second terminal apparatus. The communication unit 620 may be configured to send the first information to the first terminal apparatus.

Module division in embodiments of this application is an example, and is only logical function division. During actual implementation, there may be another division manner. In addition, functional modules in embodiments of this application may be integrated into one processor, or each of the modules may exist alone physically, or two or more modules may be integrated into one module. The integrated module may be implemented in a form of hardware, or may be implemented in a form of a software functional module.

FIG. 7 shows a communication apparatus 700 according to an embodiment of this application. The communication apparatus 700 is configured to implement the communication method provided in this application. The communication apparatus 700 may be a communication apparatus to which the communication method is applied, a component in the communication apparatus, or an apparatus that can be used in a matching manner with the communication apparatus. The communication apparatus 700 may be a first terminal apparatus or a network device. The communication apparatus 700 may be a chip system or a chip. In this embodiment of this application, the chip system may include a chip, or may include a chip and another discrete device. The communication apparatus 700 includes at least one processor 720, configured to implement the communication method provided in embodiments of this application. The communication apparatus 700 may further include an output interface 710, where the output interface may also be referred to as an input/output interface. In this embodiment of this application, the output interface 710 may be configured to communicate with another apparatus via a transmission medium, and a function of the output interface 710 may include sending and/or receiving. For example, when the communication apparatus 700 is a chip, the communication apparatus 700 performs transmission with another chip or device through the output interface 710. The processor 720 may be configured to implement the method shown in the foregoing method embodiment.

For example, the processor 720 may be configured to perform an action performed by the processing unit 610, and the output interface 710 may be configured to perform an action performed by the communication unit 620. Details are not described again.

Optionally, the communication apparatus 700 may further include at least one memory 730, configured to store program instructions and/or data. The memory 730 is coupled to the processor 720. The coupling in this embodiment of this application may be an indirect coupling or a communication connection between apparatuses, units, or modules in an electrical form, a mechanical form, or another form, and is used for information exchange between the apparatuses, the units, or the modules. The processor 720 may cooperate with the memory 730. The processor 720 may execute the program instructions stored in the memory 730. At least one of the at least one memory may be integrated with the processor.

In this embodiment of this application, the memory 730 may be a nonvolatile memory, for example, a hard disk drive (HDD) or a solid-state drive (SSD), or may be a volatile memory, for example, a random access memory (RAM). The memory is any other medium that can carry or store expected program code in a form of an instruction structure or a data structure and that can be accessed by a computer, but is not limited thereto. The memory in this embodiment of this application may alternatively be a circuit or any other apparatus that can implement a storage function, and is configured to store program instructions and/or data.

In this embodiment of this application, the processor 720 may be a general-purpose processor, a digital signal processor, an application-specific integrated circuit, a field programmable gate array or another programmable logic device, a discrete gate or transistor logic device, or a discrete hardware component, and may implement or perform the methods, steps, and logical block diagrams disclosed in embodiments of this application. The general-purpose processor may be a microprocessor, any conventional processor, or the like. The steps of the method disclosed with reference to embodiments of this application may be directly performed by a hardware processor, or may be performed by using a combination of hardware in the processor and a software module.

FIG. 8 shows a communication apparatus 800 according to an embodiment of this application. The communication apparatus 800 is configured to implement the communication method provided in this application. The communication apparatus 800 may be a communication apparatus to which the communication method shown in embodiments of this application is applied, a component in the communication apparatus, or an apparatus that can be used in a matching manner with the communication apparatus. The communication apparatus 800 may be a first terminal apparatus or a network device. The data transmission apparatus 800 may be a chip system or a chip. In this embodiment of this application, the chip system may include a chip, or may include a chip and another discrete device. A part or all of the communication method provided in the foregoing embodiments may be implemented by hardware or software. When the communication method is implemented by hardware, the data transmission apparatus 800 may include an input interface circuit 801, a logic circuit 802, and an output interface circuit 803.

Optionally, an example in which the apparatus is configured to implement functions of a receiving end is used. The input interface circuit 801 may be configured to perform a receiving action performed by the communication unit 620, the output interface circuit 803 may be configured to perform a sending action performed by the communication unit 620, and the logic circuit 802 may be configured to perform an action performed by the processing unit 610. Details are not described again.

Optionally, during specific implementation, the data transmission apparatus 800 may be a chip or an integrated circuit.

Some or all of operations and functions performed by the data transmission apparatus described in the foregoing method embodiments of this application may be implemented by using the chip or the integrated circuit.

An embodiment of this application provides a computer-readable storage medium storing a computer program. The computer program includes instructions for performing the foregoing method embodiment.

An embodiment of this application provides a computer program product including instructions. When the computer program product runs on a computer, the computer is enabled to perform the foregoing method embodiment.

An embodiment of this application provides a communication system. Specifically, the communication system may include a first terminal apparatus and a network device configured to implement the method shown in FIG. 3, or include an apparatus configured to implement the method performed by the first terminal apparatus in FIG. 3 and an apparatus configured to implement the method performed by the network device in FIG. 3. For details, refer to related descriptions in the method embodiment. The details are not described herein again. The communication system may include the structure shown in FIG. 1 or FIG. 2.

Persons skilled in the art should understand that embodiments of this application may be provided as a method, a system, or a computer program product. Therefore, this application may use a form of hardware only embodiments, software only embodiments, or embodiments with a combination of software and hardware. In addition, this application may use a form of a computer program product that is implemented on one or more computer-usable storage media (including but not limited to a disk memory, a CD-ROM, an optical memory, and the like) that include computer-usable program code.

This application is described with reference to the flowcharts and/or block diagrams of the method, the device (system), and the computer program product according to embodiments of this application. It should be understood that computer program instructions may be used to implement each procedure and/or each block in the flowcharts and/or the block diagrams and a combination of a procedure and/or a block in the flowcharts and/or the block diagrams. These computer program instructions may be provided for a general-purpose computer, a dedicated computer, an embedded processor, or a processor of another programmable data processing device to generate a machine, so that the instructions executed by a computer or a processor of another programmable data processing device generate an apparatus for implementing a specific function in one or more procedures in the flowcharts and/or in one or more blocks in the block diagrams.

These computer program instructions may alternatively be stored in a computer-readable memory that can indicate the computer or another programmable data processing device to operate in a specific manner, so that the instructions stored in the computer-readable memory generate an artifact that includes an instruction apparatus. The instruction apparatus implements a specific function in one or more procedures in the flowcharts and/or in one or more blocks in the block diagrams.

These computer program instructions may alternatively be loaded onto a computer or another programmable data processing device, so that a series of operations and steps are performed on the computer or the another programmable device, so that computer-implemented processing is generated. Therefore, the instructions executed on the computer or the another programmable device provide steps for implementing a specific function in one or more procedures in the flowcharts and/or in one or more blocks in the block diagrams.

Although embodiments of this application are described, persons skilled in the art can make changes and modifications to these embodiments once they learn of a basic inventive concept. Therefore, the following claims are intended to be construed as to cover the embodiments and all changes and modifications falling within the scope of this application.

It is clear that persons skilled in the art may make various modifications and variations to embodiments of this application without departing from the scope of embodiments of this application. In this case, this application is intended to cover these modifications and variations of embodiments of this application provided that they fall within the scope of protection defined by the following claims and their equivalent technologies.

1. A communication method, comprising:
receiving, by a first terminal apparatus, first information, wherein the first information indicates a port corresponding to a first interference layer of the first terminal apparatus, the first interference layer is one or more interference layers in a plurality of interference layers of the first terminal apparatus, and the first interference layer is a transmission layer of a second terminal apparatus; and
performing, by the first terminal apparatus, channel estimation based on the port corresponding to the first interference layer.

2. The method according to claim 1, wherein the method further comprises:
determining, by the first terminal apparatus, an equalization coefficient based on a result of the channel estimation; and
receiving, by the first terminal apparatus, data based on the equalization coefficient.

3. The method according to claim 1, wherein the performing, by the first terminal apparatus, channel estimation based on the port corresponding to the first interference layer comprises:
performing, by the first terminal apparatus, channel estimation based on a first time-frequency resource, wherein the first time-frequency resource corresponds to the port corresponding to the first interference layer.

4. The method according to claim 3, wherein the performing, by the first terminal apparatus, channel estimation based on a first time-frequency resource comprises:
performing, by the first terminal apparatus, channel estimation based on the first time-frequency resource, and a time-frequency resource corresponding to noise and/or a time-frequency resource corresponding to to-be-transmitted data.

5. The method according to claim 1, wherein the first interference layer is determined based on interference energy, and the interference energy of the first interference layer satisfies at least one of the following:
the interference energy of the first interference layer is higher than interference energy of a second interference layer, and the plurality of interference layers further comprise the second interference layer;
the interference energy of the first interference layer is not less than an energy threshold;
a proportion of the interference energy of the first interference layer in total interference energy is not less than a proportion threshold, and the total interference energy is a sum of interference energy of all interference layers of the first terminal apparatus;
the first interference layer comprises a plurality of interference layers, and a sum of interference energy of the plurality of interference layers is not less than an energy threshold;
the first interference layer comprises a plurality of interference layers, a proportion of a sum of interference energy of the plurality of interference layers in total interference energy is not less than a proportion threshold, and the total interference energy is a sum of interference energy of all interference layers of the first terminal apparatus; or
the first interference layer is N interference layers with highest interference energy in the plurality of interference layers, wherein N is a positive integer.

6. The method according to claim 1, wherein the first information comprises indication information of the port corresponding to the first interference layer and/or indication information of a port corresponding to the second interference layer, and the second interference layer does not comprise the first interference layer.

7. The method according to claim 6, wherein the first information further comprises indication information of a port group, and the method further comprises:
determining, by the first terminal apparatus based on a port corresponding to the to-be-transmitted data, a port in the port group, and the indication information of the port corresponding to the first interference layer and/or the indication information of the port corresponding to the second interference layer, the port corresponding to the first interference layer.

8. The method according to claim 1, wherein the first information comprises the indication information of the port group, and the method further comprises:
determining, by the first terminal apparatus based on the port corresponding to the to-be-transmitted data and the port in the port group, the port corresponding to the first interference layer.

9. A communication method, comprising:
determining, by a network apparatus, first information, wherein the first information indicates a port corresponding to a first interference layer of a first terminal apparatus, the first interference layer is one or more interference layers in a plurality of interference layers of the first terminal apparatus, and the first interference layer is a transmission layer of a second terminal apparatus; and
sending, by the network apparatus, the first information to the first terminal apparatus.

10. The method according to claim 9, wherein
the first interference layer is determined based on interference energy, and the interference energy of the first interference layer satisfies at least one of the following:
the interference energy of the first interference layer is higher than interference energy of a second interference layer, and the plurality of interference layers further comprise the second interference layer;
the interference energy of the first interference layer is not less than an energy threshold;
a proportion of the interference energy of the first interference layer in total interference energy is not less than a proportion threshold, and the total interference energy is a sum of interference energy of all interference layers of the first terminal apparatus;
the first interference layer comprises a plurality of interference layers, and a sum of interference energy of the plurality of interference layers is not less than an energy threshold;
the first interference layer comprises a plurality of interference layers, a proportion of a sum of interference energy of the plurality of interference layers in total interference energy is not less than a proportion threshold, and the total interference energy is a sum of interference energy of all interference layers of the first terminal apparatus; and
the first interference layer is N interference layers with highest interference energy in the plurality of interference layers, wherein N is a positive integer.

11. The method according to claim 9, wherein the first information comprises indication information of the port corresponding to the first interference layer and/or indication information of a port corresponding to the second interference layer, and the second interference layer does not comprise the first interference layer.

12. The method according to claim 11, wherein the first information further comprises indication information of a port group, and a port in the port group, a port corresponding to to-be-transmitted data of the first terminal apparatus, and the indication information of the port corresponding to the first interference layer and/or the indication information of the port corresponding to the second interference layer are used to determine the port corresponding to the first interference layer.

13. The method according to claim 9, wherein the first information comprises indication information of a port group, and a port in the port group and a port corresponding to to-be-transmitted data are used to determine the port corresponding to the first interference layer.

14. A first communication apparatus, comprising:
a communication unit, configured to receive first information, wherein the first information indicates a port corresponding to a first interference layer of a first communication apparatus, the first interference layer is one or more interference layers in a plurality of interference layers of the first communication apparatus, and the first interference layer is a transmission layer of a second communication apparatus; and
a processing unit, configured to perform channel estimation based on the port corresponding to the first interference layer.
